(19) United States
(12) Patent Application Publication
(10) Pub. No.: US 2006/0144636 A1
(43) Pub. Date: Jul. 6, 2006

(54) Rack and pinion electro-steering

(76) Inventors: Olaf Beutler, Goebingen (DE); Christian Karch, Bergrain (DE); Robert Schuler, Urbach (DE)

Correspondence Address: KENYON & KENYON LLP, ONE BROADWAY, NEW YORK, NY, 10004, US

(21) Appl. No.: 10/537,205

(22) PCT Filed: Nov. 26, 2003
(86) PCT No.: PCT/EP03/13265

§ 371 Date: Dec. 13, 2005

(30) Foreign Application Priority Data
Dec. 3, 2002 (DE) 10256314.4

(51) Int. Cl. B62D 5/04

(52) U.S. Cl. 180/443; 180/444

(57) ABSTRACT

A rack-and-pinion electro-steering system, e.g., for motor vehicles, has a rack extending in a housing, which is operatively connected to a thrust member/pinion pairing. At least one bearing between the rack and the housing is provided for guiding the rack. The bearing is arranged as a friction bearing. A construction of the bearing between the rack and the housing as a sliding bearing may be particularly suited for a reliable, durable and cost-effective guidance of the rack in the housing. In addition, for mounting the sliding bearings on the rack, a lock geometry is provided by which the sliding bearings may be locked after having been mounted on the rack. The lock geometry for example may be based on the lock geometry customary in sealing rings in automatic transmissions.

### FIELD OF THE INVENTION

The present invention relates to a rack-and-pinion electro-steering system, e.g., for motor vehicles, having a rack extending in a housing, which is operatively connected to a thrust member/pinion pairing.

### BACKGROUND INFORMATION

Rack-and-pinion electro-steering systems are operated by an electrical system instead of a hydraulic system. It is made up of an electric motor, a gear unit for power transmission as well as the control electronics and sensor system. The steering torque exercised by the driver is evaluated by the sensor system of the power steering and is converted into an electrical signal which is converted by the electric motor and the gear unit into a corresponding servo-torque and transmitted to the steering. Conventional rack-and-pinion electro-steering systems are steering column drives, pinion drives, double pinion drives as well as axially parallel drives.

In conventional rack-and-pinion electro-steering systems, the rack is thrust by one or two thrust members against a corresponding number of pinions so as to produce a good tooth-engagement between the pinion and the rack. In general, rack-and-pinion electro-steering systems have two pinions or pinion toothings, one pinion being connected to the servo-side, i.e., to the electric motor and the other pinion being connected to the sensor side or the steering column. For this purpose, the thrust members guide the rack and thrust it against the pinion toothing.

The rack-and-pinion electro-steering system can produce disturbing noises. One source of noise is the rack and another source of noise are the thrust members. The noise generation is especially high in rack-and-pinion electro-steering systems that have two thrust member/pinion pairings, due to the degrees of freedom at the rack and thrust members. The disturbing noise generation, however, occurs also in rack-and-pinion electro-steering systems that have merely one thrust member/pinion pairing. A cause of the noise generation is to be found in that the different toothing forces on the sensor side and servo-side cause a tilting of the rack which results in a knocking of the steering system particularly in rapidly alternating steering.

The tilting of the rack may also result in a high degree of wear of the pinion toothing.

Irrespective of, or in addition to, the noise generation on account of the rack, undesired noises are also generated due to the thrust members, which are embedded in a housing part, having a tendency to tilt.

Conventional thrust members are made from aluminum or generally from metal and have a sliding film at their concave contact surface facing the rack. Generally an O-ring is located between the thrust member and the surrounding housing part, which is to prevent dust from entering.

In this connection, German Published Patent Application No. 100 49 570 and the following documents should be referred to for additional background information: German Published Patent Application No. 199 29 932, German Published Patent Application No. 33 32 483, German Published Patent Application No. 694 12 701, German Published Patent Application No. 28 07 005 and German Published Patent Application No. 34 08 673.

### SUMMARY

An example embodiment of the present invention may provide a rack-and-pinion electro-steering system, which may address the above-mentioned disadvantages, preventing, e.g., the occurrence of disturbing noises in a simple and cost-effective manner and minimizing the wear of the pinion toothing.

Since, between the rack and the housing a bearing is provided for guiding the rack, the thrust members may only have to absorb the toothing forces. Disturbing noises due to a tilting of rack may thereby be prevented. Thus knocking may be avoided even in rapidly alternating steering.

The bearing between the rack and the housing may also minimize the wear of the pinion toothing in a particularly advantageous manner. In conventional systems, the tilting of the rack may result in a high degree of wear, which may be minimized since the bearing prevents a tilting of the rack.

The use of a bearing between the rack and the housing surrounding the rack may be particularly suited for rack-and-pinion electro-steering systems having two pinions which engage into the rack when thrust by the respective associated thrust member. For this purpose, one pinion is operatively connected to the servo-side of the electric motor and one pinion is operatively connected to the sensor side or to the steering column. In rack-and-pinion electro-steering systems having only one thrust member/pinion pairing, as, e.g., in a steering column drive or in a pinion drive, a reduction of the wear in the pinion toothing may be achieved as well due to the optimum guidance of the rack.

According to an example embodiment of the present invention, the bearing is arranged as a sliding bearing. A construction of the bearing between the rack and the housing as a sliding bearing may be particularly suited for a reliable, durable and cost-effective guidance of the rack in the housing.

In addition, for mounting the sliding bearings on the rack, a lock geometry is provided by which the sliding bearings may be locked after having been mounted on the rack. The lock geometry, for example, may be based on the lock geometry customary in sealing rings in automatic transmissions.

Two sliding bearings may further be provided for guiding the rack in the housing.

Guiding the rack in the housing using two sliding bearings may also allow for a particularly suitable guidance, which may eliminate a tilting of the rack and hence the occurrence of noises and a high wear of the pinion toothing.

An example embodiment of the present invention may additionally provide for the thrust member to be manufactured essentially from plastic, e.g., from a slide-modified high-performance plastic.

Due to the fact that the thrust member is essentially made of plastic, noises between the thrust member and the housing part surrounding the thrust member may be minimized. The thrust member may be manufactured using injection molding technology from a slide-modified high-performance plastic such as Torlon 4301, which produces the same thermal linear expansion as the housing material used.

Movements of the thrust member generally extend radially with respect to the rack and result from knocks or similar effects on the rack which are accordingly transmitted to the thrust member. By being made from plastic or, e.g., from a slide-modified plastic, the thrust member may readily move with respect to the housing part without causing disturbing noises and may allow for an elimination of the O-ring previously required in thrust members made of metal or aluminum, which is supposed to prevent dust, dirt, etc. from entering. The possible omission of the O-ring may eliminate another source of noise. Due to the minimal contact surface of the O-ring at the housing and its easy deformability, conventional thrust members have tended to tilt around the O-ring. In that the O-ring is eliminated herein and the thrust member is instead made from plastic, a tilting and the associated noises may be prevented.

Moreover, the previously required sliding film, which the thrust member has on its concavely formed side facing the rack, may be omitted. This may simplify the handling in the installation of the thrust member since only a single part needs to be installed. On the other hand, the manufacture of a thrust member from plastic may be possible in a simple and cost-effective manner compared to the existing thrust members made of metal or aluminum.

### BRIEF DESCRIPTION OF THE DRAWING

FIG. 1 illustrates a rack-and-pinion electro-steering system having a housing, a rack extending in the housing as well as two thrust member/pinion pairings, which are operatively connected with the rack, the rack being guided in the housing by two sliding bearings.

### DETAILED DESCRIPTION

Certain rack-and-pinion electro-steering systems are conventional and are generally used as an alternative to a hydraulic system. Rack-and-pinion electro-steering systems essentially exist as pinion drives, as double pinion drives or as axially parallel drives. Depending on the arrangement, one or two pinions engage in the rack.

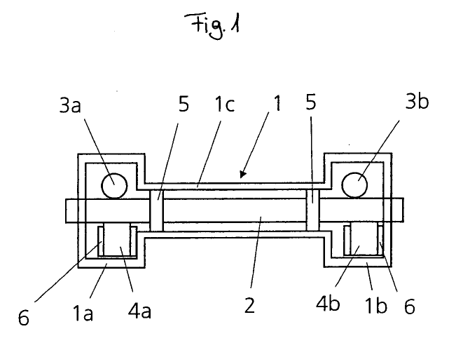

FIG. 1 illustrates a section of a rack-and-pinion electro-steering system having a housing 1 and a rack 2 extending within it. Rack 2 is operatively connected with two pinions 3a, 3b, each of which includes one thrust member 4a, 4b assigned to it. Pinion 3a is connected in the exemplary embodiment to a servo-side or an electric motor, while pinion 3b is connected to a sensor side or to a steering column.

Between rack 2 and the cylindrical part 1c of housing 1 surrounding rack 2, two bearings in the form of sliding bearings 5 are arranged. Sliding bearings 5 are used for guiding rack 2 in housing 1, which means that this task no longer has to be assumed by thrust members 4a, 4b. Thrust members 4a, 4b therefore only have to absorb the toothing forces. Housing 1, e.g., cylindrical housing part 1c, may be honed throughout.

A plastic, e.g., a high-performance plastic suitable for high temperatures, may be used as the material for manufacturing sliding bearings 5. High-performance plastics such as Solvay Torlon 4301 or DuPont Vespel SP211 may be suited for this purpose. A manufacture of sliding bearings 5 using injection molding technology may be particularly suitable. For mounting sliding bearings 5 on rack 2, a lock geometry may be provided by which sliding bearings 5 may be locked after having been mounted on rack 2. The lock geometry for example may be based on the lock geometry customary in sealing rings in automatic transmissions.

Sliding bearings 5 may be arranged in each case as closely as possible in the region of pinion 3a or 3b since occurring noises may thus be additionally attenuated. Moreover, sliding bearings 5 are thus spaced particularly far apart from each other, which may provide for a particularly advantageous guidance of rack 2. If the possibility exists, sliding bearings 5 may also be inserted in cylindrical part 1c of housing 1 as an alternative to the arrangement of sliding bearings 5 on rack 2.

Sliding bearings 5 may be arranged in a tooth-free region of rack 2 such that a contact with pinions 3a, 3b may be precluded.

In order to suppress noise generation in the region of thrust members 4a, 4b, a sliding bearing or a sliding bushing 6 may be used between thrust member 4a, 4b and housing part 1a, 1b surrounding thrust members 4a, 4b, which spans the contact region between the respective thrust member 4a, 4b and the surrounding housing part 1a, 1b. Thus a noise generation through the movement of thrust members 4a, 4b in relation to housing parts 1a, 1b may be reduced or eliminated completely.

In conventional systems, thrust member 4a, 4b made of metal or aluminum rubbed against the respective housing parts 1a, 1b, which on the one hand produced noises and on the other hand resulted in a corresponding wear. Merely the use of an O-ring between the respective thrust member 4a, 4b and housing part 1a, 1b, which was to keep out dust etc., was conventionally provided. Conventional thrust members may tilt about the O-ring and deform it, which results in the already mentioned noises and signs of wear. These noises are effectively prevented by using a sliding bushing 6 or a sliding bearing. As the exemplary embodiment reveals, sliding bushing 6 assigned to the respective thrust member 4a or 4b extends across the entire width of thrust member 4a or 4b.

Sliding bushing 6 may act as a sound buffer between the components as well as minimizing friction.

Sliding bushing 6 may be essentially made from a plastic, e.g., a high-performance plastic. For this purpose, the same high-performance plastic may be used as in the already mentioned sliding bearings 5. A manufacture using injection molding technology may be suitable.

Sliding bushings 6 may be inserted into housing part 1a, 1b.

As an alternative to sliding bearings 5 or sliding bearings 6, the use of conventional bearings or bearing bushings may be possible as well.

Thrust members 4a, 4b may be manufactured essentially from plastic, e.g., from a high-performance plastic. The high-performance plastic already described with respect to sliding bearings 5 may be suitable for this purpose. The high-performance plastic may be slide-modified as, e.g., Torlon 4301. Since thrust members 4a, 4b are essentially made of plastic, both the O-ring required in conventional systems as well as the sliding film facing rack 2 may be omitted. The required ability to slide may be ensured by thrust member 4a, 4b due to the construction made of plastic. Sliding bushing 6 may also be omitted. A construction of thrust members 4a, 4b from plastic may make it possible that only one single piece needs to be installed.

The design approach hereof is not only suitable for the rack-and-pinion electro-steering systems. Rather, the design approach hereof may fit all conventional rack-and-pinion electro-steering systems. For this purpose, in a simple arrangement, it may be possible to use only one sliding bearing 5 or generally one bearing for guiding the rack in the housing.

### REFERENCE NUMERALS

1 housing
1a housing part (thrust member 4a)
1b housing part (thrust member 4b)
1c cylindrical housing part
2 rack
3a pinion
3b pinion
4a thrust member
4b thrust member
5 bearing, sliding bearing (rack housing)
6 sliding bearing, sliding bushing (thrust member housing part)

1-12. (canceled)

13. A rack-and-pinion electro-steering system, comprising:
a housing;
at least one thrust member/pinion pairing;
a rack extending in the housing, the rack operatively connected to the thrust member/pinion pairing; and
at least one sliding bearing arranged between the rack and the housing to guide the rack, the sliding bearing lockable by a locking geometry, the sliding bearing movable with the rack and arranged in a tooth-free region of the rack to preclude contact between the sliding bearing and the pinion.

14. The rack-and-pinion electro-steering system according to claim 13, wherein the rack-and-pinion electro-steering system is adapted to be arranged in a motor vehicle.

15. The rack-and-pinion electro-steering system according to claim 13, wherein the at least one sliding bearing includes two sliding bearings.

16. The rack-and-pinion electro-steering system according to claim 13, wherein the at least one thrust member/pinion pairing includes two pinions and one thrust member associated with each pinion, a first one of the two pinions connected to a servo side of the rack and a second one of the two pinions connected to one of (a) a sensor side of the rack and (b) a steering column.

17. The rack-and-pinion electro-steering system according to claim 13, wherein the housing is honed throughout.

18. The rack-and-pinion electro-steering system according to claim 13, wherein the housing is cylindrical and is honed throughout.

19. The rack-and-pinion electro-steering system according to claim 13, wherein the sliding bearing is formed of plastic.

20. The rack-and-pinion electro-steering system according to claim 13, wherein the sliding bearing is formed of a high-temperature resistant, high-performance plastic.

21. The rack-and-pinion electro-steering system according to claim 13, wherein the sliding bearing is an injection-molded part.

22. The rack-and-pinion electro-steering system according to claim 13, further comprising one of (a) a sliding bearing and (b) a sliding bushing substantially covering a contact area arranged between a trust member of the thrust member/pinion pairing and a housing part surrounding the thrust member.

23. The rack-and-pinion electro-steering system according to claim 22, wherein the one of (a) the sliding bearing and (b) the sliding bushing is inserted into the housing part.

24. The rack-and-pinion electro-steering system according to claim 22, wherein the sliding bearing substantially covering the contact area is formed of plastic.

25. The rack-and-pinion electro-steering system according to claim 22, wherein the sliding bearing substantially covering the contact are is formed of a high-performance plastic.

26. The rack-and-pinion electro-steering system according to claim 13, wherein a thrust member of the thrust member/pinion pairing is formed of plastic.

27. The rack-and-pinion electro-steering system according to claim 13, wherein a thrust member of the thrust member/pinion pairing is formed of a slide-modified, high-performance plastic.

28. The rack-and-pinion electro-steering system according to claim 13, wherein a thrust member of the thrust member/pinion pairing is formed of a slide-modified, high-performance injection-molded plastic
